(19) United States
(12) Patent Application Publication
(10) Pub. No.: US 2010/0295821 A1
(43) Pub. Date: Nov. 25, 2010

(54) Optical touch panel

(76) Inventors: Tom Chang, Los Alto, CA (US); Andrew Grzegorek, San Jose, CA (US); Chongmei Zhang, Cupertino, CA (US); John Canfield, Union City, CA (US)

Correspondence Address: MCCRACKEN & FRANK LLP, 311 S. WACKER DRIVE, SUITE 2500, CHICAGO, IL, 60606, US

(21) Appl. No.: 12/592,109

(22) Filed: Nov. 19, 2009

Related U.S. Application Data
(60) Provisional application No. 61/216,656, filed on May 20, 2009.

(51) Int. Cl. G06F 3/042

(52) U.S. Cl. 345/175

(57) ABSTRACT

An optical touch panel assembly includes a touch panel that has photosensors and light sources, wherein each light source is energizable to produce a field of illumination that illuminates multiple photosensors at a time. The touch panel also includes control circuitry to energize and de-energize the light sources so that at least one but less than all of the light sources are turned on at a time in a sequence to illuminate an entire active area of the touch panel and to analyze output signals from the photosensors. The control circuitry is further configured to identify a low level output signal corresponding to a proximity event and to determine a location of the proximity event on the touch panel.

### CROSS REFERENCE TO RELATED APPLICATIONS

This application claims the benefit of U.S. Provisional Patent Application No. 61/216,656 filed May 20, 2009, which is incorporated by reference herein in its entirety.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Disclosure

The present disclosure relates to touch panels and, more particularly, to optical touch panels.

2. Background of the Disclosure

Touch panels disposed over or otherwise integrated with display screens, such as, an LCD panel or CRT screen, are becoming increasingly prevalent in smart phones, PDA's, notebook PC's, GPS devices, handheld or personal game consoles, ATM's, kiosks in general, and the like, to serve as an input device that allows a user to interact with a display. An input can generally be entered on the touch panel by any suitable means, e.g., one or more fingers, a palm, or a stylus.

There are a number of types of commonly used touch panel technologies, such as, resistive, capacitive, and optical touch panels. Resistive touch panels are generally composed of spaced apart layers of flexible, electrically conductive membranes. When an object contacts the resistive touch panel, the conductive membranes contact each other and function as a voltage divider to cause a change in an electrical characteristic of the touch panel. Such change in the electrical characteristic is processed to determine the location of the touch. While suitable for many applications, resistive type touch panels have their drawbacks, including reducing the clarity of the underlying display and being prone to wear and damage.

Capacitive touch panels generally include two conductive layers that form a capacitor. The capacitance between the conductive layers is responsive to contact of a conductive object with the top layer. The response of the capacitive touch panel to such contact is processed to determine the location of the contact. Capacitive touch panels are generally intended for use only with an exposed finger of a user and may not work when contacted by non-conductive objects, such as a gloved finger. Further, capacitive touch panels can become quite expensive as the size of the touch panel is increased.

Optical touch panels generally use image sensors/cameras mounted at corners of the touch panel or light sources and opposing photosensors to detect an object. In one example, cameras that have a wide field of view, e.g., around 90 degrees, are mounted at adjacent corners of the touch panel and have overlapping fields of view. The outputs of the cameras are processed to determine the location of an object with respect to the fields of view of the cameras, in turn to determine the location of the object relative to the touch panel. In another example, the touch panel includes photosensor arrays along two adjacent sides of a rectangular display and corresponding light sources along two opposing sides. The light sources create light beams across the touch panel that are detected by the photosensors. Any object that interrupts the light beams causes a decrease in received light at one or more photosensors and the location of the object on the touch panel is determined by the outputs of the photosensor(s).

Optical touch panels offer various advantages over other types of touch panels. For example, optical touch panels obviate the need for image-degrading conductive membranes or coatings disposed over the display screen. Further, optical touch panels are easily scalable to different sizes and shapes and can have increased accuracy, precision, and durability over other types of touch panel technologies. In addition, optical touch panels are capable of detecting the position of multiple simultaneous instances of proximity events and interpreting the movement of such proximity events to support advanced user interfaces. A proximity event can be defined by an object being brought into proximity or touching the surface of the optical touch panel, for example. However, prior optical touch panel designs also suffer from some drawbacks, including low sensing resolution, high power consumption, relatively high costs compared to other touch panel technologies, and inconsistent performance in high ambient light and/or optically noisy environments.

### SUMMARY OF THE INVENTION

In one example, an optical touch panel assembly includes a touch panel that has photosensors and light sources, wherein each light source is energizable to produce a field of illumination that illuminates multiple photosensors at a time. The touch panel also includes control circuitry to energize and de-energize the light sources so that at least one but less than all of the light sources are turned on at a time in a sequence to illuminate an entire active area of the touch panel and to analyze output signals from the photosensors. The control circuitry is further configured to identify a low level output signal corresponding to a proximity event and to determine a location of the proximity event on the touch panel.

In another example, an optical touch panel assembly includes a touch panel that has a light source, a photosensor, and an optical component associated with the photosensor so that the photosensor is substantially only sensitive to light emitted by the light source.

In a further example, a method of operating a touch panel that includes photosensors and light sources to determine a location of one or more proximity events on the touch panel comprises the steps of energizing and de-energizing the light sources so that at least one but less than all of the light sources are turned on at a time in a sequence to illuminate an entire active area of the touch panel and activating the photosensors to develop output signals corresponding to light that impinges on the photosensors. The method further includes the steps of analyzing the output signals from the photosensors to identify a low level output signal corresponding to a proximity event and processing the low level output signal to determine a location of the proximity event on the touch panel.

### BRIEF DESCRIPTION OF THE DRAWINGS

FIG. 1 is a block diagram of an optical touch panel assembly according to one embodiment;

FIG. 2 is a diagrammatic front elevational view of one embodiment of an optical touch panel with selected light sources turned on and an object brought into proximity of the optical touch panel at a specific location;

FIG. 3 is a flowchart that illustrates programming that may be executed by suitable control circuitry to control the operation of the optical touch panels disclosed herein;

FIG. 4 is a diagrammatic front elevational view of another embodiment of an optical touch panel;

FIG. 5 is a diagrammatic front elevational view of yet another embodiment of an optical touch panel;

FIG. 6 is a diagrammatic front elevational view of a further embodiment of an optical touch panel similar to the embodiment of FIG. 5 but with only two photosensors to illustrate differences in sensing capabilities between the embodiments of FIGS. 5 and 6;

FIG. 7 is a diagrammatic front elevational view of a still further embodiment of an optical touch panel;

FIG. 8 illustrates the optical touch panel of FIG. 7 with a different arrangement of light sources and photosensor arrays;

FIG. 9 illustrates the optical touch panel of FIG. 7 with another arrangement of light sources and photosensor arrays;

FIG. 10 is a diagrammatic front elevational view of the optical touch panel of FIG. 7 illustrating photosensors that sense light from different light sources at different incident angles depending on the positions of such photosensors relative to such light sources;

FIG. 11 is a diagrammatic front elevational view of the photosensors of FIG. 10 with optical components associated therewith to channel light from light sources at specific incident angles;

FIG. 12 is a diagrammatic cross-sectional view of an additional embodiment of an optical touch panel;

FIG. 13 is a diagrammatic partial front elevational view of a touch panel according to another embodiment;

FIG. 14 is a diagrammatic cross-sectional view of a touch panel according to a further embodiment;

FIG. 15 is a diagrammatic partial front elevational view of a touch panel according to yet another embodiment; and

FIG. 16 is a diagrammatic cross-sectional view taken generally along lines 16-16 of FIG. 15.

### DETAILED DESCRIPTION

Various embodiments and examples of optical sensors and optical touch panel assemblies are disclosed herein that incorporate aspects of different photosensor designs, arrangements/mechanical mountings for optical components, and programming to determine locations of one or more objects on the touch panel and to interpret the movement of such objects as input gestures, e.g., a slide, pinch, flick, etc. The features of each embodiment are generally interchangeable and can be used in the alternative or in combination with features discussed in relation to other embodiments. Elements that are common to the various embodiments are identified by like reference numerals.

In one example, a touch panel operates emitters and/or receivers in a multiplexed sequence preferably with one or more emitters and/or receivers operated at a time to determine characteristics of one or more simultaneous proximity events. The emitters and receivers may be light sources and photosensors, respectively, which are adapted to emit and receive light in any wavelength or ranges of wavelengths. The emitters and receivers can be arranged along sides of the touch panel, at corners of the touch panel, or along sides and at corners of the touch panel. In another example, the emitters have wide fields of illumination and the receivers have wide viewing areas so that fewer emitters are needed to illuminate the touch panel and so that fewer receivers can be used to detect a proximity event over substantially an entire active area of the touch panel. In another example, the receivers are photosensors and proximity sensors that are used to determine characteristics of one or more simultaneous proximity events.

In various embodiments, the touch panel can compensate for noise by filtering out ambient light effects and/or by modulating/demodulating the emitted and received light at specific frequencies, for example. Noise immunity may be further improved by coupling optical components to the emitters and/or by designing receivers to be more sensitive to light emitted by the emitters and/or to block out light in wavelengths outside of ranges of wavelengths emitted by the emitters, for example. In yet another example, the touch panels may include receivers with dark photosensor elements that can be used to generate values that represent dark current/voltage noise and/or temperature related current/voltage effects, wherein the touch panel can compensate for such dark noise/temperature related effects.

Further details of the above and other aspects of the present disclosure are described in more detail herein.

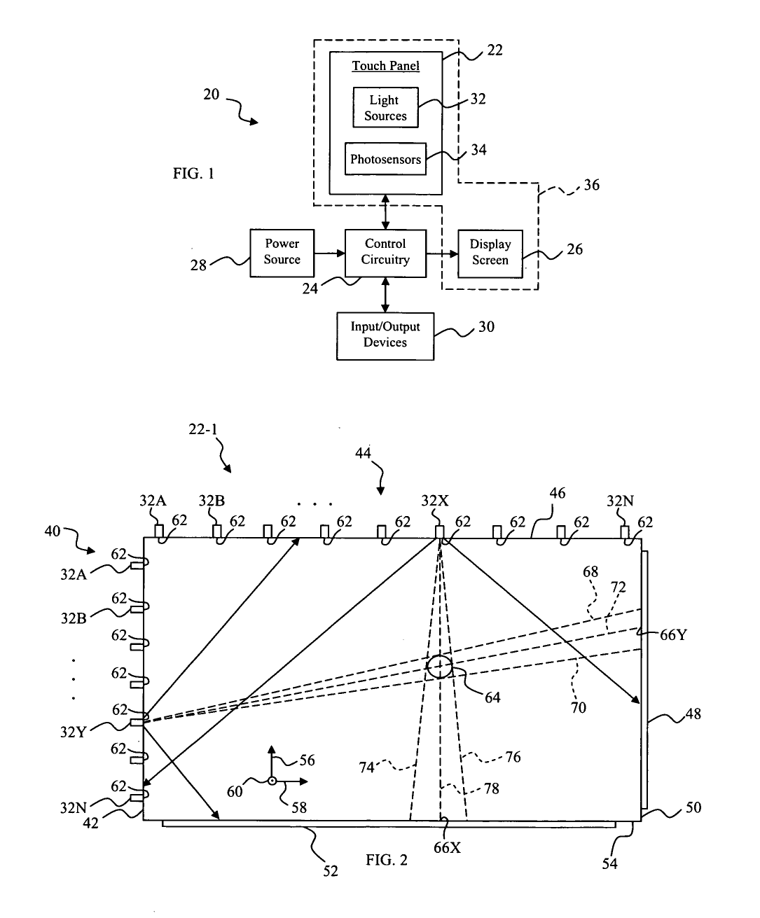

FIG. 1 shows one example of an optical touch panel assembly 20 that includes an optical touch panel 22, control circuitry 24, a display screen 26, and a power source 28. The control circuitry 24 can include any suitable hardware and/or software components, such as, an ASIC, a microcontroller, a microprocessor, a digital signal processor, memory, discrete timers, and the like. The control circuitry 24 is coupled to the display screen 26 and the touch panel 22 to control/interact with the same and the power source 28 supplies power to the electrical components of the assembly 20. The optical touch panel 22 can be disposed over the display screen 26, which displays information to provide an interactive optical touch panel assembly 20. In various embodiments, the touch panel 22 may comprise a top or outer glass layer of the display screen 26, a separate glass or other transparent material layer, a panel disposed around the display screen 26, or may be any structure associated with the display screen 26 in any other suitable manner.

In the example of FIG. 1, the touch panel 22 includes light sources 32 and photosensors 34. The control circuitry 24 is capable of controlling the light sources 32 and photosensors 34 to determine the position of one or more simultaneous proximity events and interpreting the movement of such proximity events to support advanced user interfaces, as will be described in more detail hereinafter. In other examples, the optical touch panel assembly 20 can include fewer or additional components without departing from the spirit of the present disclosure, for example, the display screen 26 may be omitted and/or one or more additional input/output devices 30 may optionally be provided, such as, a mouse and/or keyboard. Other modifications to the optical touch panel assembly 20 can also be made, for example, the optical touch panel 22 may be provided as a stand-alone component or may be a part of the display screen 26, as illustrated by the dashed line 36 of FIG. 1.

Referring to FIG. 2, an embodiment of the optical touch panel 22 of FIG. 1 is illustrated as a rectangular optical touch panel 22-1 that includes a first plurality of light sources 40 disposed along a first side 42 of the touch panel 22-1 and a second plurality of light sources 44 disposed along an adjacent second side 46 of the touch panel 22-1. Further, a first photosensor array 48 is disposed along a third side 50 of the touch panel 22-1 opposite the first side 42 and a second photosensor array 52 is disposed along a fourth side 54 of the touch panel 22-1 opposite the second side 46.

In FIG. 2, the first and third sides 42, 50 of the touch panel 22-1 are parallel to a Y axis 56 and the second and fourth sides 46, 54 are parallel to an X axis 58 that is orthogonal to the Y axis 56. Further, a Z axis 60 is generally orthogonal to the X and Y axes 56, 58, as shown in FIG. 2. In the present embodiment, the X, Y, and Z axes 56, 58, 60 define a coordinate system that is used for reference purposes only without intending any limitation to the scope of the present disclosure.

In the present embodiment, each of the first and second photosensor arrays 48, 52 can be arranged in a one-dimensional array of photosensors along the Y or X axes 56, 58, respectively, or can be arranged in two dimensional arrays along the X and Z axes 58, 60 and/or the Y and Z axes 56, 60 (hereinafter referred to as “X-Z” and “Y-Z” arrays, respectively). In FIG. 2, each of the first and second pluralities of light sources 40, 44 include discrete light sources 32A-32N that are spaced apart from each other along sides of the touch panel 22-1.

In other embodiments, the arrangement of light sources 32 and photosensors 34 along the sides of the touch panel 22 can be modified, for example, the light sources and/or photosensors can be disposed only at corners of the touch panel 22 or can be disposed at corners and along sides of the touch panel, although generally, the light sources 32 are preferably disposed on opposing corners or sides from the photosensors 34. In addition, the touch panel 22 can be any other geometric or irregular size or shape with angular or rounded corners, e.g., triangular, circular, etc., and the arrangement of light sources 32 and photosensors 34 around the touch panel can be modified accordingly so that an object can be detected at substantially any location within the boundary of the touch panel. Generally, the size and shape of the touch panel 22 will correspond to the size and shape of an underlying display screen 26 although, in some embodiments, the touch panel is not disposed over a display screen, e.g., when the touch panel is being used as a stand-alone input device.

Further, the number of photosensors 34 that make up the photosensor arrays 48, 52, the number of light sources 32 that make up the pluralities of light sources 40, 44, and the spacing or pitch between such individual elements can be varied depending on a number of different considerations, including the characteristics of the photosensors and/or light sources, the size and geometry of an active area of the touch panel 22, a desired signal to noise ratio, and on the resolution requirements of the touch panel. Other factors that may be considered to determine the number and arrangement of light sources 32 and photosensors 34 include fields of illumination of the light sources, viewing angles of the photosensors, the presence of dead zones at corners, edges, or diagonal lines of the touch panel 22, a desired resolution of the touch panel, the ability of the touch panel to detect multiple proximity events simultaneously and/or to interpret movement of such proximity events, total power consumption, cost, specifications of the control circuitry 24, such as clock speed, and the like.

In one example, the number of photosensors 34 in the arrays 48, 52 ranges from about 10-1200 photosensors-per-inch (“PPI”). The photosensor arrays 48, 52 may have PPI figures in the X, Y, and/or Z axes 56, 58, 60 that are the same or different. In addition, the light sources 32 and photosensors 34 can be equally or non-equally spaced from each other in order to optimize the ability of the touch panel 22 to accurately resolve the location(s) of one or more proximity events. Further, in order for the discrete light sources 32 of the touch panel 22 to illuminate the entire active area of the touch panel, the light sources may include optical components 62, such as, lenses, reflectors, mirrors, light guides, diffusers, collimators, polarizers, beam splitters, and the like, to disperse light with wide fields of illumination of about 45 degrees to about 150 degrees.

The present embodiment is at least distinguishable from prior optical touch panels that have light sources and opposing photosensor arrays, wherein each light source has a very narrow field of illumination to generate a grid of light beams that is substantially parallel to respective X and Y axes of the touch panel. In such prior touch panels, a photosensor output is processed to detect an object that blocks a light beam substantially directly opposite the location of the photosensor. Consequently, the pitches of the light sources and photosensors limit the resolution of such prior touch panels. In contrast, the optical touch panel 22-1 of FIG. 2 can use fewer light sources 32 with wide fields of illumination so that each photosensor 34 can detect an object over a much larger area of the touch panel 22-1. Further, the present embodiment can determine the location of an object with substantially better resolution over prior touch panels because the resolution is not as limited by the number of and spacing between the light sources 32 and photosensors 34.

In one example, the light sources 32 are coupled to a DC power source and are multiplexed to rapidly turn on and off with a timing, period, and sequence controlled by the control circuitry 24. In one embodiment, each light source 32 is controlled to turn on one at a time for a predetermined time period duration in any sequence. However, in other embodiments, the light sources 32 can be turned on several at a time and/or can be turned on for different period durations. Generally, the light sources 32 are controlled according to a sequence and timing to illuminate an entire active area of the touch panel 22 within an average or, alternatively, a minimum time period during which a proximity event is occurring at substantially the same position relative to the touch panel 22. (That is, the timing is sufficiently short as to cause illumination of the entire active area of the touch panel 22 over a brief period of time so that the position of the proximity event can be determined before significant further movement of the proximity event occurs.) The control sequence and timing can be determined and modified based on various other considerations as well, including the number and arrangement of light sources 32 and photosensors 34, the fields of illumination of the light sources, the viewing angles of the photosensors, the intended use of the touch panel 22, and the like, as would be apparent to one of ordinary skill.

When a proximity event occurs, such as when an object 64, e.g., a finger or stylus, is brought into proximity or touches a surface of the touch panel 22, the object 64 partially blocks the light from one or more light sources 32 and causes a shadow 66 to be cast along the photosensor arrays 48, 52. The shadow 66 causes a decrease in received light at one or more photosensor elements 34, which generate low voltage/current signals that represent such decrease, as compared to high voltage/current signals that are generated by the photosensor elements in the absence of the object 64 and associated shadow. The control circuitry 24 analyzes signal outputs from the photosensor arrays 48, 52 and identifies low level signals at one or more photosensor elements 34 that correspond to the shadow 66 to determine a location of the shadow along the photosensor arrays. In this regard, the photosensor arrays may develop low level signals caused by other variations in received light, e.g., changes in ambient light, changes in light from a display, variations due to non-uniform light emitted by the light sources, differences in the distances between each photosensor and multiple light sources, and the like. The present disclosure contemplates various approaches to distinguish a low signal caused by a shadow cast by a proximity event from other variations in received light. For example, the control circuitry 24 can compare the output of a photosensor element 34 before and after a low signal is detected or can analyze the outputs of adjacent photosensor elements to determine if a low signal output at a photosensor element is consistent with a proximity event. Further, the control circuitry 24 can take into account the characteristics of the light sources 32 and photosensors 34 to determine if a low signal output is consistent with a proximity event, e.g., if a field of illumination of a light source is within a viewing angle of a corresponding photosensor, if the light emitted by a light source is uniform or non-uniform across the field of illumination, and/or if the light sensed by a photosensor is uniform or non-uniform across the viewing angle.

The locations of the photosensors 34 that correspond to the shadow positions 66 can be recorded by a digital signal processor (“DSP”) block of the control circuitry 24 and processed to determine the location of the object 64. The DSP or other portions of the control circuitry 24 can keep track of the positions of the light sources 32 that are energized and the positions of photosensor(s) 34 that detect the shadow 66. The control circuitry 24 uses such information to calculate the X, Y location of the object 64 using geometric techniques, such as triangulation, or other known mathematical methods, including trigonometric techniques. In the event that multiple X, Y locations for a plurality of objects 64 are calculated, the shadow positions that correspond to multiple light sources 32 being energized are processed to determine the X, Y locations for each object. Since the calculations are based on knowing and/or tracking the position of the light sources 32 that are energized and the positions of corresponding photosensor(s) 34 that detect the shadow 66, preferably no more than one light source is turned on at a time if useable fields of view of the photosensors illuminated by such light sources overlap. However, more than one light source 32 can be turned on at a time, particularly, if the useable fields of view of the photosensors 34 illuminated by such light sources do not overlap. Generally, it is advantageous to have more than one light source 32 turned on at a time, when appropriate, to increase the speed of determining the location of a proximity event, especially for larger touch panels.

Referring to FIG. 2, a proximity event caused by an object 64 results in different shadow positions 66 when different light sources 32 are turned on. For example, when light source 32Y is turned on, the object 64 casts a shadow at a range of points 66Y extending parallel to the Y axis 56 of the photosensor array 48. Further, when light source 32X is turned on, the object 64 casts a shadow at a range of points 66X extending parallel to the X axis 58 of the photosensor array 52. In general, the ranges of points 66Y, 66X along the photosensor arrays 48, 52 that correspond to the shadow 66 cast by the object 64 depend on the thickness of the object and, in some situations, may further depend on the distance and movement of the object in relation to the touch panel 22. For example, if the object is a human finger, then a first shadow may be cast by a tip of the finger as the finger approaches the touch panel, a larger second shadow may be cast by the finger as it touches the touch panel, and an even larger third shadow may be cast as the finger is pressed against and deformed against the touch panel. In this example, the control circuitry 24 can record data for each of the first, second, and third shadows (and other shadows intermediate the first, second, and third shadows and/or shadows that occur before the first and/or after the third shadows) and process the data to determine that the outputs of the photosensors correspond to a proximity event. In addition, the data can be further processed to determine characteristics of the proximity event in addition to the position, e.g., the size of the object, the velocity of a moving object, a direction and distance that an object is moving, etc. Such velocity and position data can be interpreted by the control circuitry 24 to recognize gestures, such as an object tapping the touch panel or softly sweeping over the touch panel, which can be used to support more advanced user interfaces used in tablet PC's, cell phones and other mobile devices, personal game consoles, and the like.

Referring again to FIG. 2, the shadows at the point ranges 66Y, 66X cause decreases in received light at corresponding photosensor elements 34, which generate low level voltage and/or current signals that represent such decrease in received light. In this regard, where the photosensor arrays 48, 52 include photosensors 34 spaced sufficiently close together, multiple adjacent photosensors may develop output levels that indicate a shadow (or at least a partial shadow) is formed at a sensing surface of each such photosensor (photosensors that are located at an edge of such a shadow may receive attenuated light rays caused by scattering effects). The control circuitry 24 analyzes signal outputs from the photosensor arrays 48, 52 and identifies low level signals caused by the shadow(s) 66 cast by proximity event(s) to determine the locations of photosensor elements 34 that detect the shadow(s). In the illustrated embodiment, the control circuitry records one or more photosensor locations around the photosensor ranges 66X, 66Y and processes data, such as, the photosensor locations, the positions of the corresponding light sources 32X, 32Y that were turned on when the low level signals were detected, the fields of illumination of the light sources, other characteristics of the light sources and photosensors, the known geometry of the touch panel 22, and the like, to determine the X and Y coordinates of the object 66 on the touch panel.

In one example, the control circuitry 24 develops equations defining first and second lines 68, 70, respectively, extending from an illuminated light source 32Y along the outer boundaries of a shadow area cast on the point range 66Y and further determines a mathematical function or other definition of a third line 72 between the first and second lines 68, 70. In similar fashion, the control circuitry 24 develops equations defining fourth and fifth lines 74, 76, respectively, extending from an illuminated light source 32X along the outer boundaries of a shadow area cast on the point range 66X and further determines a mathematical function or other definition of a sixth line 78 between the fourth and fifth lines 74, 76. The third and sixth lines 72, 78 may be equidistant from the first and second lines 68, 70 and equidistant from the fourth and fifth lines 74, 76, respectively, and generally correspond to a center of the object 64 or may be any other lines that correspond to any other portions of the object as would be apparent to one of ordinary skill. In the present example, these calculations/determinations are performed for each illuminated light source to obtain multiple third and sixth lines. The control circuitry 24 determines the point(s) where at least one (and, preferably, more than one) of the third lines intersects at least one (and, preferably, more than one) of the sixth lines and the coordinates of such point(s) may be interpreted as the location(s) of one or more proximity events.

In another example, the control circuitry 24 can determine mathematical functions or other definitions of areas between the first and second lines and the fourth and fifth lines, respectively. These calculations/determinations are performed for each illuminated light source to obtain multiple area definitions. The control circuitry 24 determines the points where at least one (and, preferably, more than one) area defined by the first and second lines intersects at least one (and, preferably, more than one) area defined by the fourth and fifth lines and the coordinates of such points may be interpreted as the location(s) of one or more proximity events.

Using these methods, the control circuitry 24 may simultaneously determine the position and/or track the movement of multiple proximity events on any of the touch panels disclosed herein. In addition, the optical touch panel 22 may include 2D photosensor arrays extending in the X-Z and/or Y-Z directions and the control circuitry 24 can utilize the outputs of such photosensor arrays to facilitate the sensing of the velocity of an object as the object approaches the touch screen and to more accurately determine the location of the object.

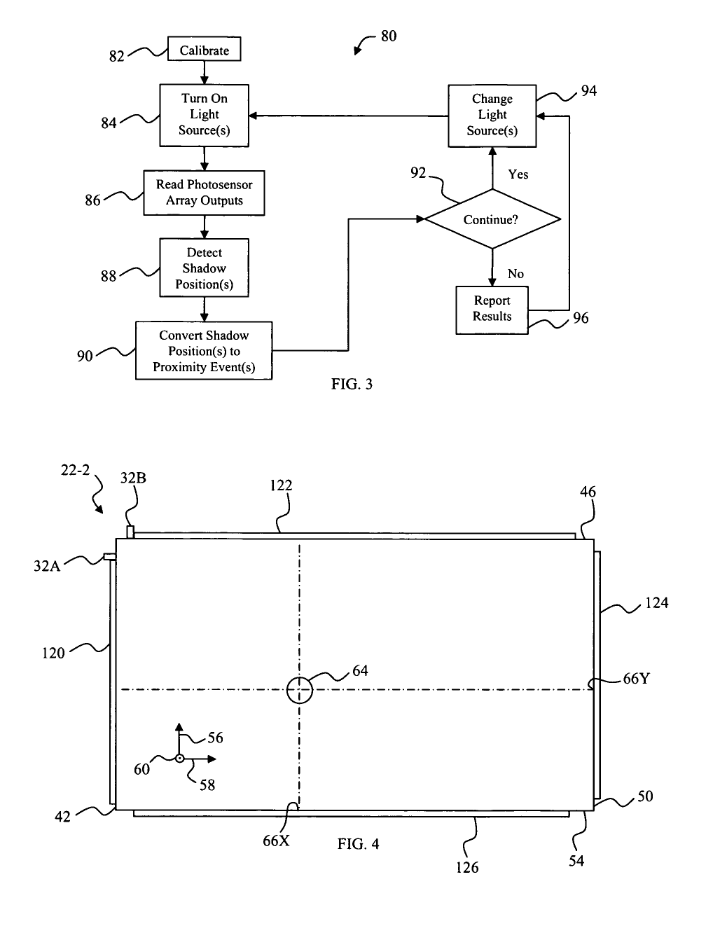

FIG. 3 illustrates an example of programming 80 implemented by control circuitry, such as the control circuitry 24 of FIG. 1, to resolve the locations of one or more proximity events on any of the touch panels 22 disclosed herein. The programming of FIG. 3 is may be included with other programming that utilizes the detection and interpretation of proximity events to achieve one or more useful results. For example, the detection of a proximity event can be used to cause changes in a display, such as, moving a cursor, filing in a radio button, typing text, moving to a subsequent screen, etc.

The programming 80 of FIG. 3 begins at a block 82 that calibrates the touch panel. For example, the calibration of the touch panel may be performed periodically or during manufacture or initialization of the touch panel. The calibration can be accomplished by instructing a user to touch one or more specific locations identified by display images while one or more light sources are energized. A touch by the user at the specific locations results in one or more shadow positions along the photosensor arrays. The control circuitry processes such shadow positions along with the known positions of the identified touch locations and energized light sources to determine a calibration factor that is stored by the control circuitry and used to calibrate the touch panel. In one example, the calibration factor may be a function of the response(s) from the photosensors to an object positioned at a known location with a plurality of light sources that are multiplexed on and off, either individually or multiply. For example, the calibration factor can be a ratio of the consolidated responses from the photosensors when one or more corresponding light sources are turned on and off. In some embodiments, the light sources may emit light non-uniformly across the fields of illumination of the light sources and/or the photosensor arrays may sense light non-uniformly across the viewing angles of the photosensors. The calibration factors can be different for each light source/photosensor to compensate for such non-uniformities across the panel.

Following the block 82, control passes to a block 84 that turns on and off one or more light sources according to a predetermined or variable sequence. Next, control passes to a block 86 that reads photosensor array outputs. In one example, the blocks 84 and 86 may, but need not, synchronize the light sources and photosensors such that the photosensors 34 are activated at the same time as energization of at least one of the light sources 32 to reduce the total power used by the optical touch panel. Following the block 86, a block 88 detects one or more shadow positions, if any, based on the photosensor array outputs.

Further, the blocks 84-88 may perform a filtering function to compensate for ambient light effects and other sources of noise that may affect the ability of the touch panel to accurately determine the location of a proximity event. In one example, the block 88 calculates an ambient light effect as a difference in light conditions detected by the photosensors 34 with and without one or more of the light sources 32 turned on and subtracts or otherwise filters out such ambient light effect from the outputs of the photosensors 34. In another example, the blocks 84-88 can modulate one or more light sources at a specific frequency and demodulate the light received at one or more photosensors at the same specific frequency to filter out interference from other light sources.

After the block 88, a block 90 converts the shadow position(s) parallel to the X and Y axes 58, 56 to positions of one or more proximity events with respect to the touch panel. In one example, the block 90 processes the shadow position(s) that correspond to the center and/or the boundaries of the object with other data, such as, the positions of the corresponding light sources that were energized when the outputs of the photosensors were sensed, the fields of illumination of such light sources, and/or the known geometry of the touch panel, to determine the X and Y coordinates of the proximity events using known mathematical methods.

Following the block 90, a decision block 92 determines whether the shadow positions detected by the block 88 correspond to positions that can be produced by the one or more light sources turned on by the block 84 and further determines whether other light sources are to be energized so that an entire active area of the touch panel has been evaluated. If the shadow positions do not correspond to positions that can be produced by the light source(s) turned on by the block 84 or if the entire active area of the touch panel has not been evaluated, then control passes to a block 94 and thereafter back to the blocks 84-90 and the control sequence energizes one or more other light sources and reads the photosensor array outputs. In the present embodiment, subsequent passes through the blocks 84-90 allow the control circuitry to obtain additional data for a proximity event over time with different light sources turned on. Such additional data may be used to identify more accurately the occurrence of proximity event(s) from the outputs of the photosensor arrays, to refine the position of the proximity event(s), to interpret a proximity event as a gesture, and the like. If the entire active area of the touch panel has been evaluated and the shadow positions correspond to positions that can be produced, then control passes to a block 96 to output the positions of the proximity events or that no proximity events were detected. As discussed generally above, the output from the block 96 can be used to achieve one or more useful results, e.g., to cause changes in a display. After the block 96, control loops back to the block 94 to continue sequencing light sources on and off and reading the photosensor outputs to monitor the touch panel for proximity events.

Various modifications to the present programming can be implemented, including modifying the order of the blocks and removing or adding blocks, as would be apparent to those of ordinary skill in the art. For example, in the present embodiment, the block 86 reads the photosensor outputs after the block 84 turns on the light source(s). However, in other embodiments, the photosensor outputs can be read continuously or at discrete times before the light source is turned on and after the light source is turned off.

Referring now to FIG. 4, another embodiment of the optical touch panel 22 of FIG. 1, here shown as an optical touch panel 22-2, includes a first optical component 120, such as, a lens, reflector, mirror, light guide, diffuser, collimator, polarizer, beam splitter, and the like, disposed along a first side 42 of the touch panel 22-2 and a second optical component 122 disposed along a second side 46 of the touch panel 22-2. The touch panel 22-2 of FIG. 4 includes a first photosensor array 124 disposed on a third side 50 of the touch panel opposite the first side 42 and a second photosensor array 126 disposed on a fourth side 54 of the touch panel opposite the second side 46. The first and second optical components 120, 122 receive light from one or more light sources, here shown as separate light sources 32A, 32B, such as IR LED's, powered by a DC current with a timing controlled by the control circuitry 24 of FIG. 1. In the present embodiment, the first and second optical components 120, 122 can comprise light guides made from an optically transparent material with a geometric design that channels the light from the light sources 32 to emit light in a certain direction, such as, substantially perpendicularly from the first and second sides 42, 46, respectively, toward the opposing edges of the touch panel 22-2. Typical materials of light guides include polymer, glass, or bundles of fiberglass. Other known designs of light guides or other optical components can be used without departing from the spirit of the present disclosure.

In use, when an object 64 is brought into proximity with the touch panel 22-2, the object 64 partially blocks the light emitted by the first and second optical components 120, 122 and causes shadows 66Y, 66X to be cast at positions along the photosensor arrays 124, 126, respectively. In the present embodiment, control circuitry 24 coupled to the touch panel 22-2 determines the positions of photosensors 34 that correspond to the shadow positions 66Y, 66X along the photosensor arrays 124, 126, as in the previous embodiment. The positions of the photosensors 34 correspond to the Y and X coordinates of the object 64 on the touch panel 22-2.

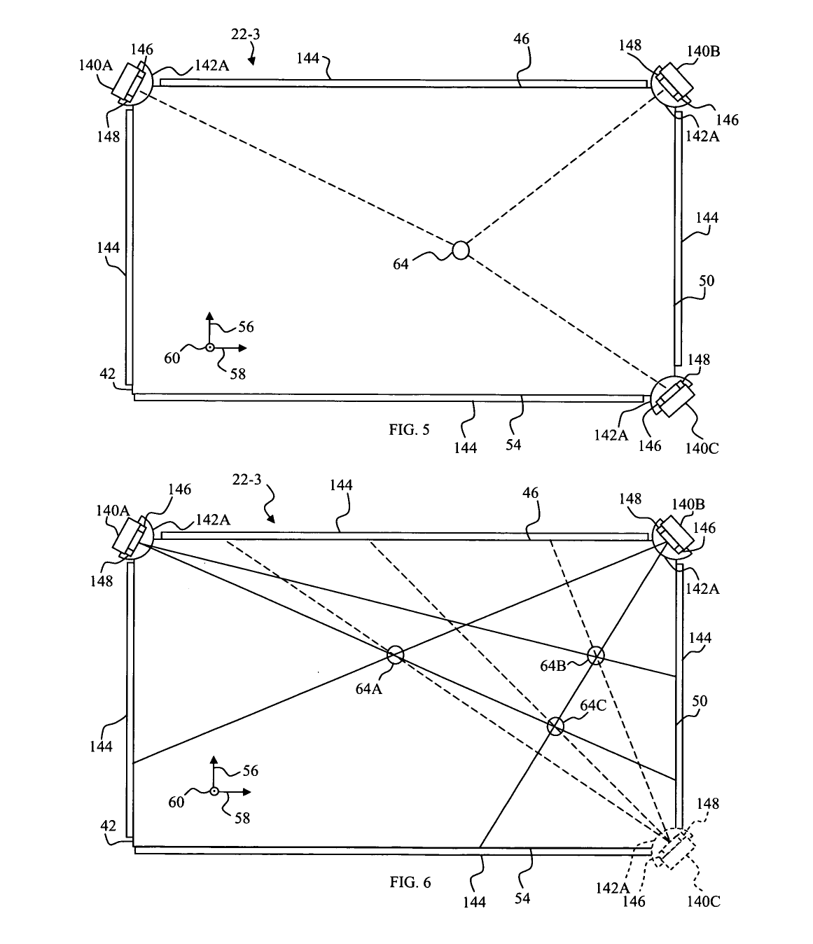

The embodiment of FIG. 5 illustrates another embodiment of the optical touch panel 22 of FIG. 1, here shown as an optical touch panel 22-3 that includes photosensor arrays 140 disposed at one or more corners of the touch panel. The illustrated embodiment includes three photosensor arrays 140A-140C, which are useful to accurately determine the position of multiple proximity events simultaneously. However, in other embodiments, fewer or additional photosensor arrays 140 can be used without departing from the spirit of the present disclosure. In the present embodiment, the photosensor arrays 140A-140C are associated with optical components 142A-142C, such as, lenses, light guides, diffusers, collimators, polarizers, beam splitters, and the like, to provide an approximately 90 degree viewing angle so that the photosensor arrays 140 can view the entire area of the touch panel 22-3. Further, the photosensor arrays 140 can be 1D or 2D X-Z and/or Y-Z photosensor arrays.

In the illustrated embodiment, the touch panel 22-3 includes light sources 144, such as IR LED's, that are energized to illuminate the touch panel and provide background lighting so that the photosensor arrays 140 can detect a difference in received light caused by a proximity event. The light sources 144 can be disposed at corners of the touch panel 22-3 and/or along one or more edges thereof and may transmit light to light guides or other optical components disposed around the touch panel. In one embodiment, one light source 144, and preferably more than one light source 144, is associated with a corresponding photosensor 140 and such light sources are simultaneously energized to obtain a large signal to noise ratio for the detection of an object 64. For example, each photosensor array 140 can correspond only to opposing light sources 144 being energized with adjacent light sources kept off when the photosensor is being used to detect the object 68.

FIGS. 5 and 6 provide example arrangements of photosensor arrays 140 to determine multiple proximity events simultaneously. In FIG. 6, the touch panel 22-3 includes two photosensor arrays 140A, 140B, mounted at adjacent corners that are sufficient to determine the location of most single and multiple proximity events simultaneously. However, in the example of FIG. 6, the touch panel would have difficulty detecting simultaneously the location of the multiple proximity events represented by objects 64A, 64B, 64C. In particular, the object 64C would likely be undetected because the objects 64A, 64B obstruct the object 64C from the fields of view of the photosensor arrays 140A, 140B. In contrast, if the touch panel 22-3 includes an additional photosensor array 140C, as in the embodiment of FIG. 5, the touch panel is better able to detect simultaneously the location of all three proximity events represented by the objects 64A-64C because each of the objects can be individually resolved in the field of view of the photosensor array 140C, as shown by the dashed lines in FIG. 6. In FIG. 6, the dashed and solid lines are used for clarity purposes only without intending any limitation. In another variation of the touch panel 22-3 of FIG. 5, the photosensor arrays 140A, 140C can be offset (in position and/or orientation) along a diagonal line between the respective corners of the touch panel 22-3. Such offsets can further improve the ability of the touch panel 22 to detect and interpret simultaneous multiple proximity events.

In use, the photosensors 140 are operated one at a time with corresponding light sources energized to detect one or more proximity events on the touch panel 22-3. In other embodiments, multiple photosensors 140 can be operated at a time, particularly if the fields of view of such photosensors do not overlap. When an object 64 is brought into proximity with the touch panel 22-3 of FIG. 5 or 6, the photosensor arrays 140 detect a decrease in light caused by the object 68 partially blocking light from opposing light guides. In one embodiment, the control circuitry 24 uses the processes described hereinabove to identify the photosensors 34 of the photosensor arrays 140 that have a different response from adjacent or neighboring photosensors. The control circuitry 24 can triangulate or otherwise process the positions of such identified photosensors 34 at multiple photosensor arrays 140 to determine a location of the object 64 on the optical touch panel 22-3.

The photosensor arrays 140 of FIGS. 5 and 6, and any of the other photosensor arrays disclosed herein, may include photosensors 34 and distance or proximity sensors 146. The photosensors 34 are used to measure a position of one or more proximity events with respect to the photosensor array 140, as described hereinabove, and the proximity sensors 146, such as time-of-flight (“TOF”) sensors, are used to measure the distance of an object 64 from the photosensor arrays 140. Generally, a proximity sensor 146 includes or is otherwise configured with a light source 148, such as an IR LED, visible LED, or laser LED that emits light at any suitable wavelength, at the same corner where the proximity sensor is disposed. The light source 148 is energized to generate a pulse of IR light and the proximity sensor 146 measures the time it takes for the light to travel to an object and back to the proximity sensor, wherein the measured time is correlated to a distance of the object from the proximity sensor. In another example, the proximity sensors 146 can be the same as or similar to the photosensors 34 and detect a level of light intensity that corresponds to light emitted by a light source, e.g., the light sources 144 and/or 148, that is reflected off of an object and back to the proximity sensor. In the present example, the detected intensity of the reflected light is correlated to a distance of the object from the proximity sensor 146. If there are multiple proximity sensors 146, a light source 148 associated with a given proximity sensor can be modulated at a specific frequency and the light received at the given proximity sensor can be demodulated at that specific frequency to filter out interference from other light sources. In one embodiment, a distance measurement is performed utilizing a proximity sensor 146 when only an associated light source 148 is on and other light sources are off. The combination of a distance measurement and a shadow position measurement can be utilized in any of the embodiments disclosed herein and may enhance the accuracy of the touch panel and can further facilitate the detection of multiple proximity events simultaneously.

Various photosensor designs that include combined photosensors and proximity detectors are disclosed in U.S. application Ser. No. 12/220,578 filed on Jul. 25, 2008, and U.S. Provisional Application No. 61/205,190 filed on Jan. 20, 2009, each of which is incorporated by reference herein in its entirety. Generally, using a combined photosensor and proximity sensor provides the benefit of reducing the number of sensors that are required to accurately resolve a location of an object. For example, a photosensor portion of a single photosensor and proximity sensor can be used to detect a relative position of an object in the field of view of the sensor, e.g., an angle of the object from a center, edge, or other reference point within the field of view, and a proximity sensor portion of the single sensor can determine a distance of the object from the sensor. Such relative position and distance information can be processed by control circuitry to determine the position of the object within the touch panel. While a single sensor with a photosensor portion and a proximity sensor portion may be sufficient to determine a location of an object, in some embodiments, additional photosensors can be used to increase the speed and/or accuracy of such determinations and/or to better detect the location of multiple proximity events simultaneously.

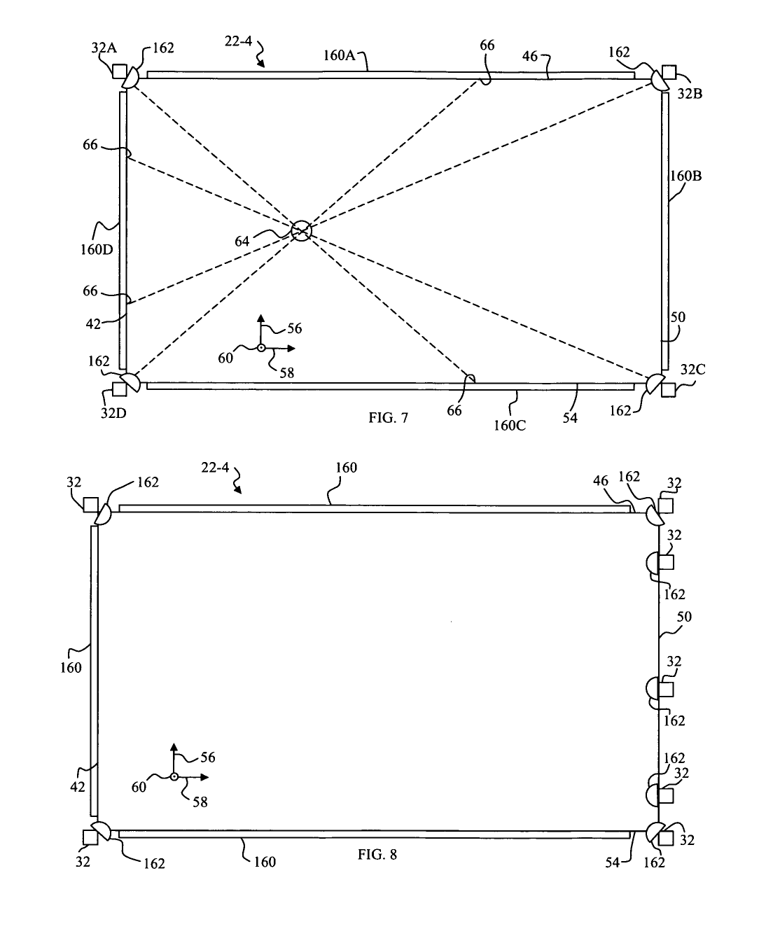

FIG. 7 illustrates another embodiment of the optical touch panel 22 of FIG. 1, here shown as an optical touch panel 22-4, that includes two or more light sources 32 mounted at corners of the touch panel 22-4 and two or more photosensor arrays 160 disposed along side edges of the touch panel 22-4. The light sources 32 at the corners of the touch panel 160 may each include one or more light sources, such as IR LED's, visible LED's, etc. Further, the light sources 32 can be equipped with lenses, light guides, a diffuser, or other optical components 162 to provide a wide field of illumination of about 90 degrees to illuminate the entire touch panel 22-4. While FIG. 7 illustrates light sources 32A-32D in each of the corners of the touch panel 22-4 and photosensor arrays 160A-160D along each of the sides of the touch panel, in other embodiments, light sources 32 in at least two corners of the touch panel and photosensor arrays 160 along at least two sides of the touch panel 160 may be sufficient to determine simultaneously the position of one or more proximity events. For example, the touch panel 22-4 may include photosensor arrays 160 along two opposing sides and may include a plurality of spaced apart light sources 32 at the corners and/or along the adjacent sides of the touch panel.

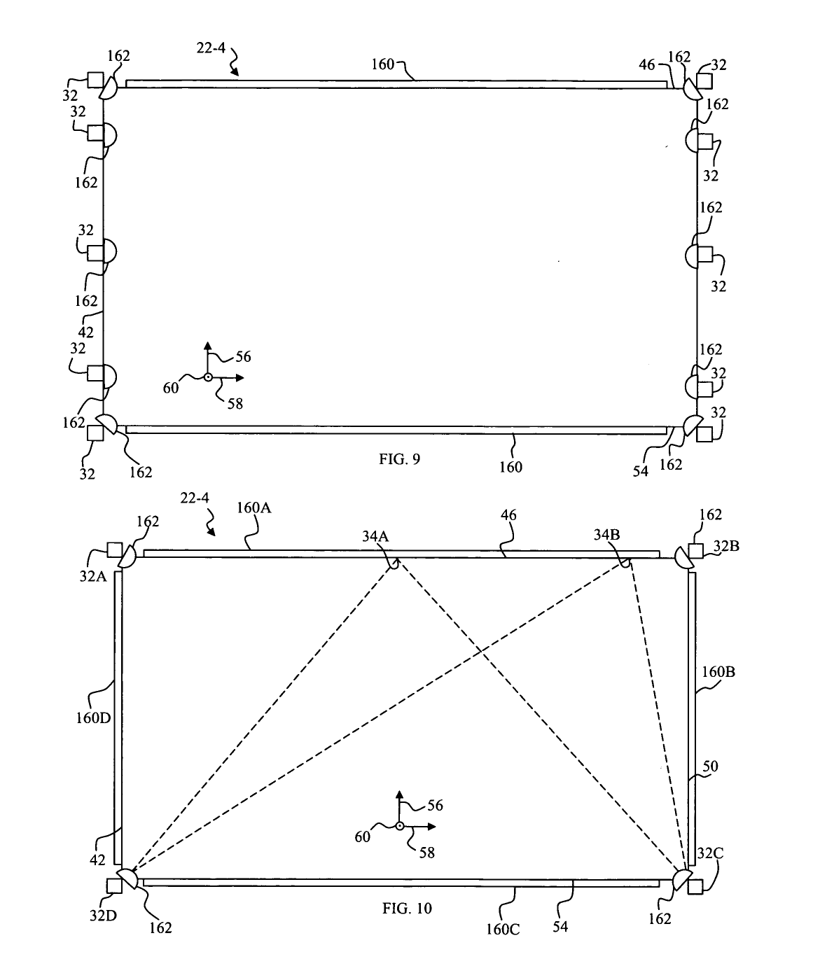

In embodiments where fewer photosensor arrays are used, e.g., two or three photosensor arrays instead of four, the cost of the optical touch panel is generally reduced. However, there is also a trade-off in the reduced ability of such touch panels to recognize exact locations of multiple proximity events. This reduction in ability to recognize exact locations of multiple proximity events may be minimized if additional light sources 32 are disposed along the sides of the touch panel 22-4. If light sources 32 are disposed along sides of the touch panel 22-4, then optical components 162 can be associated therewith to increase the field of illumination to about 180 degrees, if desired. FIGS. 8 and 9 illustrate various non-limiting examples of optical touch panels similar to the touch panel 22-4 of FIG. 7 with different arrangements of light sources 32 and photosensor arrays 160.

In use, when an object 64 is brought into proximity of or touches the touch panel 22-4, the object blocks light emitted by the light sources 32, which are turned on one at a time to avoid interference from multiple energized light sources. Alternatively or in conjunction, the light sources 32 and photosensors 34 can be modulated/demodulated at specific frequencies, as described above. FIG. 7 illustrates an example of different shadow positions 66 caused by the object 64 and registered by the photosensor arrays 160 when various light sources 32 are turned on. The various shadow positions 66 are processed by the control circuitry 24 to determine the position of a proximity event on the touch panel 22-4 caused by the object 64, as described hereinabove.

In some embodiments disclosed herein, photosensors 34 may not be disposed at the corners of the optical touch panel 22, e.g., in the touch panel 22-4 of FIG. 7. Instead, only light sources 32 are mounted at the corners of the touch panel. However, the embodiment of FIG. 7 (and any other embodiment disclosed herein) may be modified to include photosensors 34 and light sources 32 in one or more corners of the touch panel. For example, the touch panel 22 may include a photosensor 34 above, below, and/or on a side of the light sources 32 mounted at the corners of the touch panel and these photosensors disposed at the corners of the touch panel can eliminate a small dead zone along the diagonal lines of the optical touch panel where the touch panel would otherwise have difficulty accurately detecting an object. In another example, the photosensors 34 can be placed within a small spacing from the light sources 32 so that the photosensors can generally detect at least portions of an object disposed at the dead zones. In yet another embodiment, the light sources 32 disposed at the corners may comprise an LED, which is used to emit light and is also configured to function as a basic photosensor. For example, the control circuitry 24 can monitor the voltage across an anode and cathode of the LED while the LED is not emitting light. The voltage across the LED when turned off is proportional to the incident light on the LED. Consequently, the corner LED's can be used as photosensors when not emitting light and objects in the diagonal dead zone can be detected.

In another example, the light sources, photosensors, and or proximity sensors of any of the touch panels disclosed herein can be combined with optical components, such as, lenses, light guides, diffusers, collimators, polarizers, beam splitters, and the like, that are designed so that the light sources direct light primarily in certain direction(s) and/or so that the photosensors and proximity sensors are primarily sensitive to light from specific direction(s). For example, the optical components can allow the photosensors and/or proximity sensors to sense light that comes only from the light sources disposed around the touch panel. In one embodiment, the optical components substantially block out light from above and below the plane of the photosensors on the touch panel. In other embodiments, the optical components are also designed to receive more light from specific angle ranges within the plane of the photosensors on the touch panel.

Referring now to FIGS. 10 and 11, another embodiment of the touch panel 22-4 of FIG. 7 includes photosensor arrays 160 that are combined with optical components 180, such as, lenses, light guides, diffusers, collimators, polarizers, beam splitters, and the like, so that photosensors 34 are substantially only sensitive to light from the light sources 32 disposed around the touch panel 22-4. In the current example, light from the light sources 32 impinges on the photosensor arrays 160 at different angles at different positions along the arrays (see, e.g., light emitted by light sources 32C, 32D impinging on photosensors 34A, 34B at different incident angles). In the present embodiment, the photosensor arrays 160 are combined with optical components 180 that are designed so that each photosensor 34 along the photosensor array 160 is substantially only sensitive to light within the plane of the touch panel 22-4 from the light sources 32 at specific incident angles. For example, in FIG. 11 the photosensors 34A, 34B receive light from the light sources 32C, 32D at different incident angles. First and second optical component(s) 180A, 180B, respectively, are configured with respect to the photosensors 34A, 34B so that the photosensors substantially only receive light from the light sources 32C, 32D at about such incident angles. The configuration of optical component(s) 180 for other photosensors 34 of the arrays 160 would be similar except that the optical component(s) would be disposed at other angles based on the position of such photosensors with respect to the light sources 32.

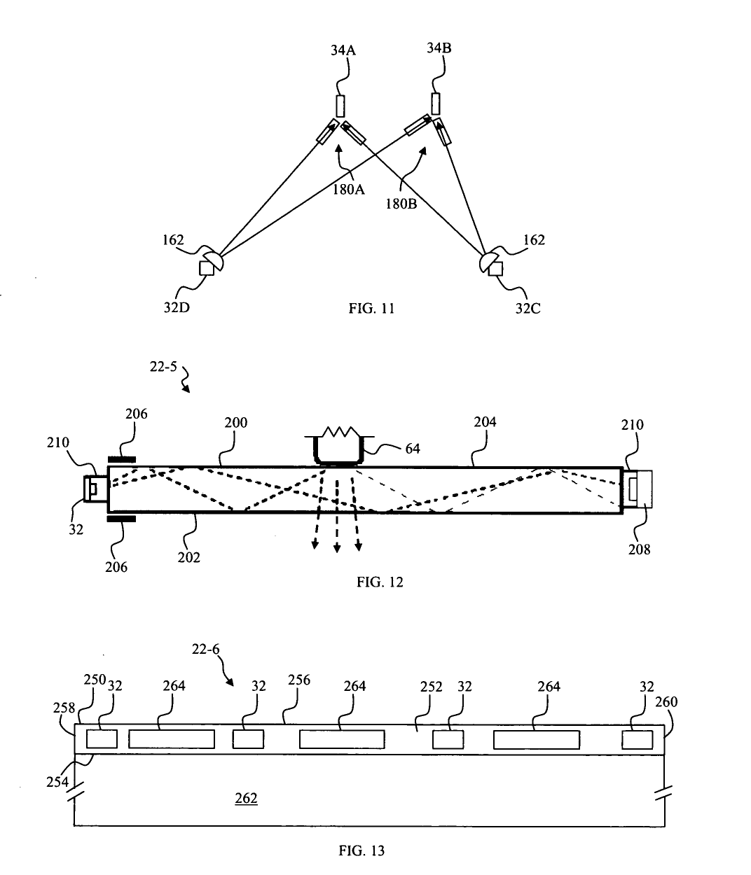

FIG. 12 illustrates another embodiment of the optical touch panel 22 of FIG. 1 here shown as an optical touch panel 22-5 with one or more light sources 32 disposed between first and second major surfaces 200, 202, respectively, of a transparent layer 204 of the touch panel, such as a glass or acrylic layer. One or more optical components 206 are disposed proximate the light source(s) 32 to focus the emitted light to transmit through the transparent layer 204 to a photosensor array 208 disposed along an opposing side of the touch panel 22-5. Further, the light source(s) 32 and photosensor array 208 can be coupled to the transparent layer 204 by any suitable attachment means 210, which in one example, includes an epoxy or other adhesive with an index of refraction that allows light to transmit into and out of the transparent layer with little or no reflected light. In one example, the attachment means 210 has an index of refraction that is substantially similar to the index of refraction of the transparent layer 32. Further, the various arrangements of light sources, photosensor arrays, proximity sensors, optical components, and any other components disclosed herein in relation to other embodiments may be utilized with the embodiment of FIG. 12. For example, the optical touch panel 22-5 may be a rectangular touch panel with discrete light sources and opposing photosensor arrays, similar to FIGS. 2 and 3.

The touch panel 22-5 of FIG. 12 utilizes principles of frustrated total internal reflection, wherein an object 64 that contacts a major surface 200, 202 of the transparent layer 204 causes the light emitted from the light source 32 to be attenuated, e.g., to be transmitted through a major surface and out the transparent layer 204, as the light is reflected within the transparent layer 204 to the photosensor array 208. The photosensor array 208 is coupled to the control circuitry 24, which determines shadow position(s) registered along the photosensor array 208 caused by the object deflecting light away from the transparent layer 204 and processes the shadow position(s) to determine a location of the object 64 on the touch panel 22-5. Even though the principles of shadow formation are different in this embodiment compared to other embodiments disclosed herein, the processes to determine the location of an object are similar and apply to embodiments where light is emitted over the surface of the touch panel and where light is emitted into a transparent layer of the touch panel.

Yet another embodiment of an optical touch panel 22-6 is shown in FIG. 13, wherein the arrangement of photosensor arrays and other components around the touch panel are such as to minimize the bezel height of the touch panel. As seen in FIG. 13, in one embodiment, a photosensor array die 250 includes a top edge 252, an opposing bottom edge (not shown), a front face 254, a back face 256, and first and second side edges 258, 260, respectively. The die 250 includes photosensors 32 located along the top edge 252 and a wire bond (not shown) preferably positioned at the bottom edge or along a side edge 258, 260 of the die 250. In use, the photosensor die 250 is mounted along sides of the touch panel 22-6 with the photosensors 32 positioned slightly above an upper surface 262 of the touch panel and the wire bond positioned below the upper surface 262. In one example, the photosensors 32 are placed less than about 5 mm above the upper surface 262. In another example, the photosensors 32 are placed less than about 1 mm above the upper surface 262. In the present embodiment, the photosensor array die 250 also includes signal conditioning circuitry 264 disposed between the photosensors 32. The signal conditioning circuitry 264 interacts with the control circuitry 24 to process the outputs of the photosensors 32 and determine characteristics of one or more proximity events. Examples of signal conditioning circuitry are disclosed in U.S. application Ser. No. 12/220,578 filed on Jul. 25, 2008. In the present embodiment, the photosensor array die 250 can be easily incorporated into existing electronic devices at a low cost and with minimal modifications to such devices because of the on-board signal conditioning circuitry 264.

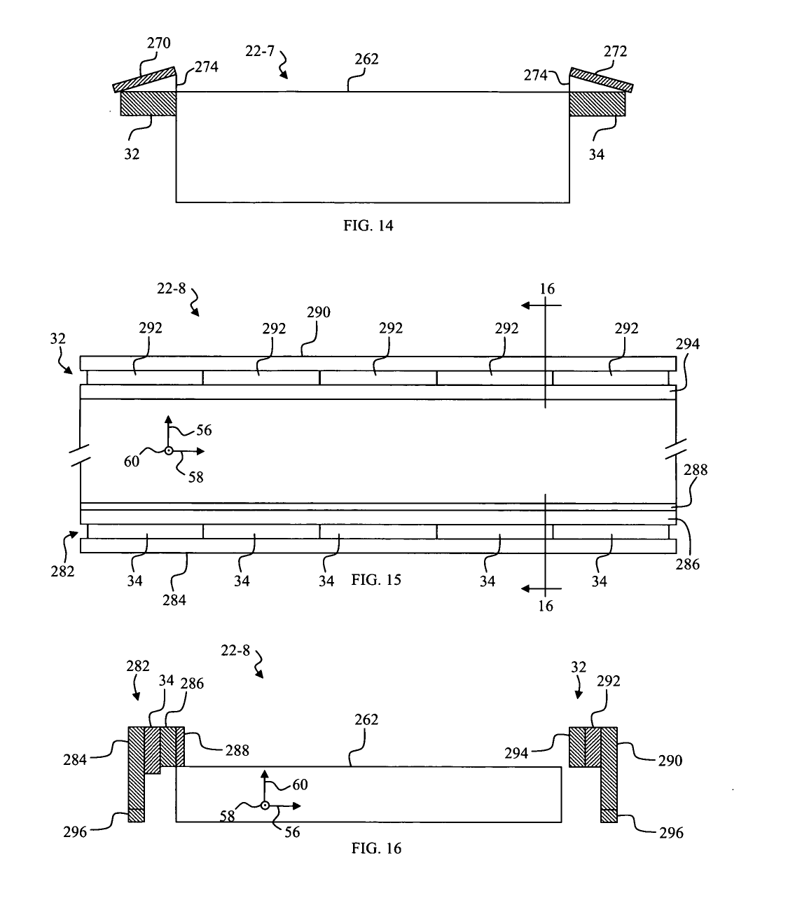

FIG. 14 illustrates a further example of an optical touch panel 22-7 that includes light sources 32 and photosensors 34 that are positioned substantially planar with or below an upper surface 262 of the touch panel. The touch panel 22-7 includes an optical component 270 associated with the light sources 32 to reflect or bend light emitted therefrom so that the light is directed across the upper surface 262 towards the photosensors 34. Similarly, an optical component 272 is associated with the photosensors 34 to reflect or bend received light to impinge on a sensing surface of the photosensors. Consequently, a bezel height of the touch panel 22-7 can be reduced relative to other touch panel designs where the bezel height is dependent on the size and arrangement of light sources and photosensors that are positioned above the upper surface 262 of the touch panel. Further, the optical components 270, 272 in the touch panel 22-7 can be configured so that the photosensors 34 are substantially only sensitive to light emitted across the upper surface 262 of the touch panel by the light sources 32. The optical components 270, 272 can be any suitable components, such as, reflectors or mirrors, so that light emitted by the light sources is directed across the touch panel 22-7 and impinges on the sensing surface of the photosensors. The touch panel 22-7 may also include a structure 274, such as a glass ridge, between the optical components 270, 272 and the light sources 32 and photosensors 34 to prevent debris from building up therebetween. Other modifications can be made to the touch panel 22-7 within the scope of the present disclosure, such as providing optical components associated with only one of the light sources and photosensors and/or adjusting the configuration of the optical components, light sources, photosensors, and/or the touch panel to be at different positions and/or angles with respect to one another.

FIGS. 15 and 16 illustrate another example of an optical touch panel 22-8 with a photosensor array die 282 disposed along one side of the touch panel 22-8 and a light source 32 disposed along an opposite side. The photosensor array die 282 includes a printed circuit board (“PCB”) substrate 284, a plurality of photosensors 34 coupled to the substrate 284, and one or more optical components 286, as described herein, and optical coatings 288 disposed over the photosensors 34. The light source 32 also includes a PCB substrate 290, one or more light source elements or chips 292, each chip comprising a die with one or more IR LED's, for example, and one or more optical components 294, as described herein, disposed over the light source chip(s) 292. Referring more specifically to FIG. 16, each of the photosensor array die 282 and the light source 32 further includes a wire bond 296 coupled to the substrate 284, 290, respectively. The photosensor array die 282 and the light source 32 are generally arranged so that at least a sensing surface of the photosensors 34 and a light emitting portion of the light source chip(s) 292 are disposed above an upper surface 262 of the touch panel 22-8. In other embodiments, the optical touch panel 22-8 can be modified to include fewer or additional components and/or to rearrange the configuration of such components. For example, the photosensor array die 282 may include signal conditioning circuitry, as described above.

Referring again to the various components of the photosensor array die 282, the photosensors 34 are typically fabricated from silicon wafers but can be fabricated from other known materials and by any known method without departing from the spirit of the present disclosure. The dimensions of the photosensors 34 will generally vary depending on the specifications of the particular application but can be on the scale of about one centimeter down to a few micrometers. Multiple photosensors 34 are bonded to the PCB substrate 284 with the multiple photosensors 34 being preferably (but not necessarily) stacked along the Z axis 60 and disposed on the substrate 284 along the X and/or Y axes 58, 56 with small spacing between the photosensors 34.

The optical component(s) 286 associated with the photosensors 34 refract away or otherwise block light rays from reaching the photosensors that are not directed in substantially the same plane as light emitted by the light source 32. In one embodiment, the optical component(s) 286 preferably provide a small viewing angle along the Z axis 60, e.g., less than about 20 degrees, for the photosensors 34. In one example, such an optical component 286 includes a lens with a flat transparent surface disposed at an angle relative to the sensor die 282 such that light that impinges on the optical component at incident angles outside of a certain range (e.g., greater than about 20 degrees) will be attenuated, reflected, and/or refracted to substantially prevent such light from impinging on the photosensors 34. Consequently, the optical component(s) 286 allow the photosensors 34 to sense light that comes substantially only from the light source 32 and blocks out ambient and background light. The optical coating 288 associated with the photosensors 34 filters out light in wavelengths other than the wavelengths emitted by the light source 32, as described in more detail hereinbelow. The optical coating 288 may be applied directly to the front of the photosensors 32, for example, by a wafer coating method. Referring to the light source 32, the optical component 294 is configured to provide a relatively small field of illumination along the Z axis 60 and a relatively wide field of illumination along X and/or Y axes 58, 56. Other modifications can be made to the present embodiment without departing from the spirit of the present disclosure.

In the various embodiments disclosed herein, the light sources 32 can be light emitting diodes (“LED's”) that emit infrared (“IR”) light with a wavelength greater than about 700 nm and below about 100 microns, and more preferably between about 720 nm and about 1050 nm. However, the touch panels 22 can alternatively utilize light sources 32 that emit light of any other visible or non-visible wavelength or range of wavelengths. In another example, the light sources 32 can emit laser light in any suitable wavelength. The laser light emitted by such light sources can be scanned over a relatively wide field of illumination using known techniques and components, such as mirrors, lenses, and the like. In yet another example, the light sources 32 can be coupled with a liquid crystal display that can be used to sequence the light sources 32 on and off.

Other aspects of any of the optical touch panels 22 disclosed herein include the design of the photosensors 34 to be more robust and less sensitive to ambient light effects and other sources of noise that affect the ability of the touch panel to accurately determine the location of an object. Various photosensor designs and methods of operation are disclosed in U.S. Provisional Application No. 61/107,594 filed on Oct. 22, 2008, which is incorporated by reference herein in its entirety.

In one example, the light sources 32 are IR LED's and the photosensors 34 are more sensitive to IR light than to light at other wavelengths. One such IR sensitive photosensor includes an additional poly-silicon layer over a P-type substrate of a common optical sensor. Alternatively or in combination, the photosensors 34 include a first photosensor that is sensitive to both IR and visible light and a second photosensor that is sensitive to visible light only. The responses from the first and second photosensors can be processed, e.g., by subtraction, to provide the function of a photosensor that is primarily sensitive to the IR light spectrum without requiring an external IR-pass filter. In other examples, the light sources emit light in other wavelengths and the photosensors are more sensitive to such wavelengths of light emitted by the light sources.

In another example, the light sources are IR LED's and the photosensors include IR-pass coatings to minimize non-IR wavelength light interference from ambient light sources, a display back light, and other sources of noise. The IR-pass coatings can be any suitable coating to filter or block out light with wavelengths shorter than about 700 nm. In other examples, the light sources emit light in other wavelengths, e.g., visible or ultraviolet, and the photosensors are adapted with coatings to block out light in wavelengths other than the wavelengths emitted by the light sources.

Further, the photosensor arrays can include one or more dark photosensor elements, e.g., an IR optical sensor covered with one or more metal layers to block the entry of IR light. The dark photosensor elements can be used to generate reference values that represent dark current (or voltage) noise and temperature related current (or voltage) effects. The control circuit can use the reference values from the dark pixels to compensate for such noise and temperature related effects and obtain more accurate position coordinates for an object.

Other embodiments of the disclosure including all the possible different and various combinations of the individual features of each of the foregoing described embodiments are specifically included herein.

### INDUSTRIAL APPLICABILITY

The optical sensors and optical touch panel assemblies disclosed herein can be implemented in a wide variety of applications, e.g., smart phones, PDA's, notebook PC's, GPS devices, handheld or personal game consoles, ATM's, kiosks, etc. In various embodiments disclosed herein, the optical sensors and touch panel assemblies are configured to improve performance, lower power consumption, increase sensing resolution, lower costs, and provide other benefits that would be apparent to one of skill in the art.

Numerous modifications to the present disclosure will be apparent to those skilled in, the art in view of the foregoing description. Accordingly, this description is to be construed as illustrative only and is presented for the purpose of enabling those skilled in the art to make and use the disclosure and to teach the best mode of carrying out the same. The exclusive right to all modifications within the scope of this disclosure is reserved.

We claim:

1. An optical touch panel assembly, comprising:
a touch panel that includes photosensors and light sources, wherein each light source is energizable to produce a field of illumination that illuminates multiple photosensors at a time; and
control circuitry to energize and de-energize the light sources so that at least one but less than all of the light sources are turned on at a time in a sequence to illuminate an entire active area of the touch panel, to analyze output signals from the photosensors, to identify a low level output signal corresponding to a proximity event, and to determine a location of the proximity event on the touch panel.

2. The optical touch panel assembly of claim 1, wherein the light sources have fields of illumination between about 45 to about 180 degrees.

3. The optical touch panel assembly of claim 1, wherein the touch panel is rectangular, light sources are disposed at two or more corners of the touch panel, and photosensor arrays are disposed along two or more sides of the touch panel.

4. The optical touch panel assembly of claim 3, wherein at least one light source disposed in a corner of the touch panel is an LED and the control circuitry is configured to monitor the voltage across the LED while the LED is not energized to operate the LED as a photosensor.

5. The optical touch panel assembly of claim 3, further comprising one or more light sources disposed along one or more sides of the touch panel.

6. The optical touch panel assembly of claim 1, wherein the touch panel is rectangular, the light sources are spaced apart along two sides of the touch panel, and photosensor arrays are disposed along two sides of the touch panel opposite the light sources.

7. The optical touch panel assembly of claim 1, wherein the photosensors are arranged in two-dimensional arrays of photosensors.

8. The optical touch panel assembly of claim 1, wherein the control circuitry is configured to determine if the low level output signal is consistent with a proximity event by performing one or more operations, including analyzing output signals from the photosensor that developed the low level output signal before and after the low level output signal was developed, analyzing output signals from one or more photosensors adjacent the photosensor that developed the low level signal, analyzing characteristics of the light sources and photosensors, and determining if the low level output signal could be produced by one or more light sources energized at the time the low level output signal was identified.

9. The optical touch panel assembly of claim 1, wherein the control circuitry is configured to synchronize activation of the photosensors and energization and de-energization of associated one or more light sources to reduce power consumption.

10. The optical touch panel assembly of claim 1, wherein the control circuitry is configured to perform a filtering function to compensate for noise, wherein the filtering function includes one or more operations, including modulating light emitted by one or more light sources at a specific frequency and demodulating light received at one or more photosensors at the same specific frequency, and calculating an ambient light effect as a difference in output signals from the photosensors with and without one or more light sources energized and compensating for such ambient light effect.

11. The optical touch panel assembly of claim 10, wherein the output signals from the photosensors without one or more light sources energized is an average of output signals before and after the one or more light sources are energized.

12. The optical touch panel assembly of claim 1, wherein the touch panel is rectangular, photosensors are disposed at three or more corners of the touch panel, and wherein the photosensors have a viewing angle of about 90 degrees.

13. The optical touch panel assembly of claim 12, wherein the light sources are disposed along edges of the touch panel and each photosensor is associated with opposing light sources, and wherein the control circuitry is configured to analyze the output signals of the photosensors one at a time when only the associated light sources are energized.

14. The optical touch panel assembly of claim 12, wherein photosensors in opposite corners are offset along a diagonal line between such corners.

15. The optical touch panel assembly of claim 1, further comprising one or more optical components associated with the photosensors so that the photosensors are substantially only sensitive to light emitted by the light sources of the touch panel.

16. The optical touch panel assembly of claim 1, wherein the light sources emit light in a specific range of wavelengths and the photosensors are more sensitive to light in the specific range of wavelengths than light in wavelengths outside of the specific range.

17. The optical touch panel assembly of claim 1, wherein the light sources emit light in infrared wavelengths and the photosensors include a first photosensor that is sensitive to light in infrared and visible wavelengths and a second photosensor that is sensitive to light in only visible wavelengths, and wherein the control circuitry is configured to process the outputs of the first and second photosensors to provide the function of a photosensor that is primarily sensitive to light in infrared wavelengths.

18. The optical touch panel assembly of claim 1, wherein the light sources emit light in a specific range of wavelengths and the photosensors include coatings to block out light in wavelengths outside of the specific range.

19. The optical touch panel assembly of claim 1, further comprising a dark photosensor element, wherein the control circuitry is configured to process an output signal developed by the dark photosensor element to generate a reference value that represents noise and/or temperature related effects, and further wherein the control circuitry is configured to utilize the reference value to compensate for such noise and/or temperature related effects.

20. The optical touch panel assembly of claim 1, wherein the touch panel further includes a transparent layer with first and second major surfaces, and wherein the light sources are disposed along one or more sides of the touch panel between the first and second major surfaces and the photosensors are disposed along one or more sides of the touch panel opposing the light sources between the first and second major surfaces.

21. The optical touch panel assembly of claim 1, wherein the touch panel further includes a proximity sensor and the control circuitry is configured to control the proximity sensor to determine a distance of the proximity event from the proximity sensor and process the distance to determine the location of the proximity event on the touch panel.

22. The optical touch panel assembly of claim 21, further comprising a plurality of proximity sensors, wherein each proximity sensor is associated with one or more light sources and the control circuitry is configured to determine the distance of the proximity event from each proximity sensor when only associated one or more light sources are energized.

23. The optical touch panel assembly of claim 1, wherein the control circuitry is configured to energize more than one light source to be turned on at a time if a field of view of the photosensors illuminated by such light sources do not overlap.

24. An optical touch panel assembly, comprising:
a touch panel that includes a light source, a photosensor, and an optical component associated with the photosensor so that the photosensor is substantially only sensitive to light emitted by the light source.

25. The optical touch panel assembly of claim 24, wherein the optical component provides a viewing angle orthogonal to a plane of the photosensors and the touch panel of less than about 20 degrees to substantially block light from above and below the plane of the photosensors and the touch panel.

26. The optical touch panel assembly of claim 24, wherein the touch panel is rectangular and includes light sources disposed at two or more corners thereof and a plurality of photosensors disposed along two or more sides thereof, wherein optical components are associated with the plurality of photosensors to block light outside of specific angle ranges within a plane of the photosensors and the touch panel, wherein the angle ranges include angles at which light emitted by the light sources is incident on the photosensors.

27. The optical touch panel assembly of claim 24, wherein the light source and the photosensor are positioned substantially planar with or below an upper surface of the touch panel, and wherein the touch panel further includes a first optical component associated with the light source to direct light emitted therefrom across the upper surface towards the photosensor and a second optical component associated with the photosensor to direct light emitted by the light source to impinge on a sensing surface of the photosensor.

28. A method of operating a touch panel that includes photosensors and light sources to determine a location of one or more proximity events on the touch panel, comprising the steps of:
energizing and de-energizing the light sources so that at least one but less than all of the light sources are turned on at a time in a sequence to illuminate an entire active area of the touch panel;
activating the photosensors to develop output signals corresponding to light that impinges on the photosensors;
analyzing the output signals from the photosensors to identify a low level output signal corresponding to a proximity event; and
processing the low level output signal to determine a location of the proximity event on the touch panel.

29. The method of claim 28, wherein the steps of energizing and activating are performed so that the activation of photosensors is in synchronization with the energization and de-energization of associated light sources to reduce power consumption.

30. The method of claim 28, further comprising the step of performing a filtering function to compensate for noise, wherein the filtering function includes at least one of modulating one or more light sources at a specific frequency and demodulating light received at one or more photosensors at the same specific frequency, and calculating an ambient light effect as a difference in output signals from the photosensors with and without one or more light sources energized and compensating for such ambient light effect.

31. The method of claim 30, wherein the output signals from the photosensors without one or more light sources energized is an average of output signals before and after the one or more light sources are energized.

32. The method of claim 28, further comprising the step of calibrating the touch panel to determine a calibration factor.

33. The method of claim 32, wherein the step of calibrating includes the steps of instructing a user to touch one or more specific locations identified on the touch panel while one or more light sources are energized and analyzing output signals from the photosensors in response to the user touching the one or more specific locations to determine the calibration factor.
